(19) United States
(12) Patent Application Publication
(10) Pub. No.: US 2003/0036938 A1
(43) Pub. Date: Feb. 20, 2003

(54) Method and system for delivery of products within a predetermined time period

(75) Inventors: Rabindranath Dutta, Austin, TX (US); Dwip N. Banerjee, Austin, TX (US)

Correspondence Address: Darcell Walker, 8107 Carvel Lane, Houston, TX, 77036, US

(73) Assignee: INTERNATIONAL BUSINESS MACHINES CORPORATION, ARMONK, NY

(21) Appl. No.: 09/931,294

(22) Filed: Aug. 16, 2001

(51) Int. Cl. G06F 17/60

(52) U.S. Cl. 705/8; 705/26

(57) ABSTRACT

The present invention describes a delivery method and system that enables deliveries to arrive at destination within the time period specified by the entity responsible for ordering the delivery. This invention provides an initial supplier of an item and also an alternate supplier of the item. The alternate supplier is preferably located in the proximity of the destination location. During the delivery process, the progress of the shipment is tracked and periodic determinations are made as to whether the shipment will be delivered at the predetermined time. If during the delivery process, there is a determination that the shipment will not reach the designated destination at the predetermined time, the alternate supplier will be contacted to supply to the item to be delivered to destination. Since, this alternate supplier is in close proximity to the destination location, this supplier should be able to deliver the order within the specified time period.

### FIELD OF THE INVENTION

This invention relates to a method and system for delivering products and in particular to a method and system for ensuring the delivery of products or other items to a designated destination within a predetermined time period using alternative suppliers and shipping entities.

### BACKGROUND OF THE INVENTION

The cornerstone of free enterprise is the purchase of goods and services. In many transactions the buyer and the seller are in different locations. This situation often times requires the seller/merchant to ship the goods to the buyer. In another case, a manufacturer produces a product that has to be transported to the distributors for sale to the public. In addition to the shipping requirements of products needed in the business world, many businesses have a need to ship packages (not necessarily products) that contain all sorts of information to other businesses or customers. Although shipping of products or other items is necessary for most businesses, shipping does have some disadvantages.

Historically, businesses have had the necessary task of delivering parcels (i.e., goods and/or documents) to their customers. The need for keeping records of when and to whom the parcels were delivered necessitated the generation of paper documents to record each transaction. Large commercial enterprises such as retail chains, and even large governmental functions such as mail delivery (i.e., C.O.D., parcel post, or return receipt mail) can generate amounts of paper, which are difficult and expensive to handle both in labor and storage costs.

More recently, third party parcel delivery firms have developed which provide delivery services on a global scale for millions of parcels daily. This requires the generation of large amounts of paperwork for tracking each parcel as it moves through the sender's organization, to each of the various components of the third party delivery firm, such as receiving station, sending location trucking department, freighter or aircraft shipping, receiving location trucking, and finally to the customer whose signature must be obtained, returned, and stored for proof of delivery.

Parcel tracking has been addressed in some areas, particularly in the area of parcel identification, by the development of bar codes and bar code scanners that allow identification of goods by machine. Bar code scanners are old and well known in the art. This approach is used in inventory checking systems, retail sales terminals, etc. However, while scanning systems provide an improved ability to identify appropriately marked goods, they do not address the problem of obtaining signature records to prove receipt of goods. Thus, the problems related to paper handling and storage remain, due to the requirement for signature records.

In addition to the administrative load, delivery service quality has become almost as important to many customers as the quality of supplied goods. More and more, customers tend to make purchasing decisions based upon service performance of suppliers. Thus, it has become very important for suppliers to evaluate their own service performance and to provide the results of such evaluations to customers. Suppliers and their customers often cooperate to evaluate service performance.

On-time product delivery is an important service component of many high-volume supply businesses. A customer typically orders a product for delivery on a specified date. The customer expects that the delivery will be no later than that date. However, the customer also does not want the delivery to be too early. The customer considers the delivery to be on time only if it is within an on-time window.

One current method for delivery of products such as flowers, is to have a network of stores or merchants located at various geographic locations. When there is an order for flowers, a determination is made as to which merchant will fill the order. If the initial merchant, the one receiving the order from the customer can meet the delivery requirements of the customer, that merchant usually handles the order. However, if the delivery site was in a different region, a merchant in that region could be contacted to fill the order. Because the contacted merchant is local to the customer, the order could be filled within the time requirements of the customer. However, the drawback is that this system is effective when there is a network of merchants.

With the explosion in use of the Internet, more and more items are bought and sold over the Internet. Global computer networks such as the Internet offer the great ability to bridge the distance between the supplier and the buyer bringing the world community together. The Internet also offers unique opportunities to develop new fail over mechanisms while conducting business. In addition, associated with the use of the Internet are substantially increased numbers of persons requiring delivery of purchased products. Some of these products have preferred delivery dates because of special events or occasions. Other items have delivery dates because the products are perishable. Most delivery systems today focus on the tracking of the items to ensure that the items do not get lost. However, these devices do not focus on the assurance that the delivery will be at the designated destination at the predetermined time. There remains a need for a method and system that can assure the delivery of a product with the requirements of the customer purchasing the product.

### SUMMARY OF THE INVENTION

It is an objective of the present invention to provide a delivery system that ensures the delivery of a product or item to a designated destination within a predetermined time period.

It is a second objective of the present invention to provide a method and system that tracks the progress of a delivery and determine whether that delivery will reach the designated destination within a predetermined time period.

It is a third objective of the present to provide a delivery method that ensures product delivery through an alternate supplier source, in the event there is a determination that the initial shipment of the product will not reach the destination within the predetermined time period.

The present invention is a product delivery method and system that can be implemented over a communication network. The system of the present invention comprises a program that processes product purchase and shipping information, a tracker to monitor the product delivery, a switchover mechanism, a database to store delivery progress information and a communication interface. It is possible that resources that performs the tasks of each server can be located in one server. The system of the invention also has a business database and a shipping and handling database. Customers and suppliers can communicate with each other and access the databases via a global communication network such as the Internet.

The present invention describes a delivery method and system that enables a delivery of a product to a destination within the time period specified by the entity responsible for ordering the delivery. This invention involves the use of an initial supplier of an item and an alternate supplier of the ordered product. The alternate supplier is preferably located in the proximity of the destination location. During the delivery process, the progress of the shipment is tracked and periodic determinations are made, based on the shipment progress, whether the shipment will be delivered at the predetermined time. If during the delivery process, there is a determination that the shipment will not reach the designated destination at the predetermined time, a substitute order will be placed with an alternate supplier to be delivered to the destination. Since, this alternate supplier is in close proximity to the destination location, this supplier should be able to deliver the order within the specified time period.

The initial implementation of the invention would be similar to any other current delivery procedure. For example, a typical ordering scheme is an integrated system such as a flower delivery system. The delivery of the orders can be tracked using package/shipment-tracking numbers. Most sites currently allow this or it can be made a condition to get the shipping business. If it appears that the delivery cannot be made in time, the system of the present invention performs a switchover to a local channel of delivery. It procures the item from a local supplier, but probably at a higher price. In this case, the customer may even get two shipments. It is important that the delivery gets to the destination in the specified time period. This onetime delivery maintains the shipping and selling entity's goodwill, which is especially important in a situation where people's emotions and feelings are involved.

### DESCRIPTION OF THE DRAWINGS

FIG. 1 depicts data processing equipment a system that can be utilized to implement the present invention;

FIG. 2 is a diagram of a computer network over which delivery and shipping information may be transmitted between suppliers, shipping and handling entities and clients;

FIG. 3 is a flow diagram of the delivery method of the present invention.

FIG. 4 is a more detailed flow diagram of the method of the present invention.

FIG. 5 is a structural diagram of the business server of the present invention.

FIG. 6 is a structural diagram of the components in the system of the present invention.

### DETAILED DESCRIPTION OF THE INVENTION

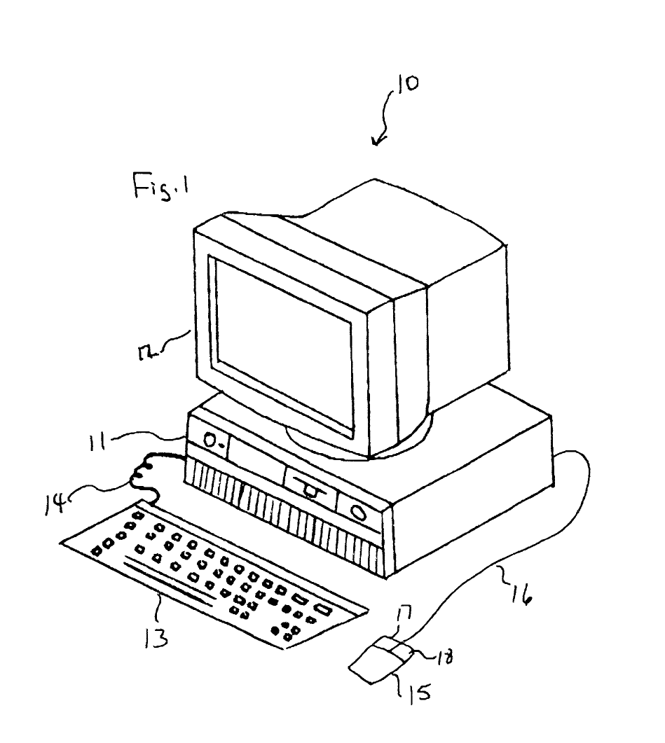

With reference now to FIG. 1, there is depicted a pictorial representation of data processing system 10 which may be used in implementation of the present invention. As may be seen, data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

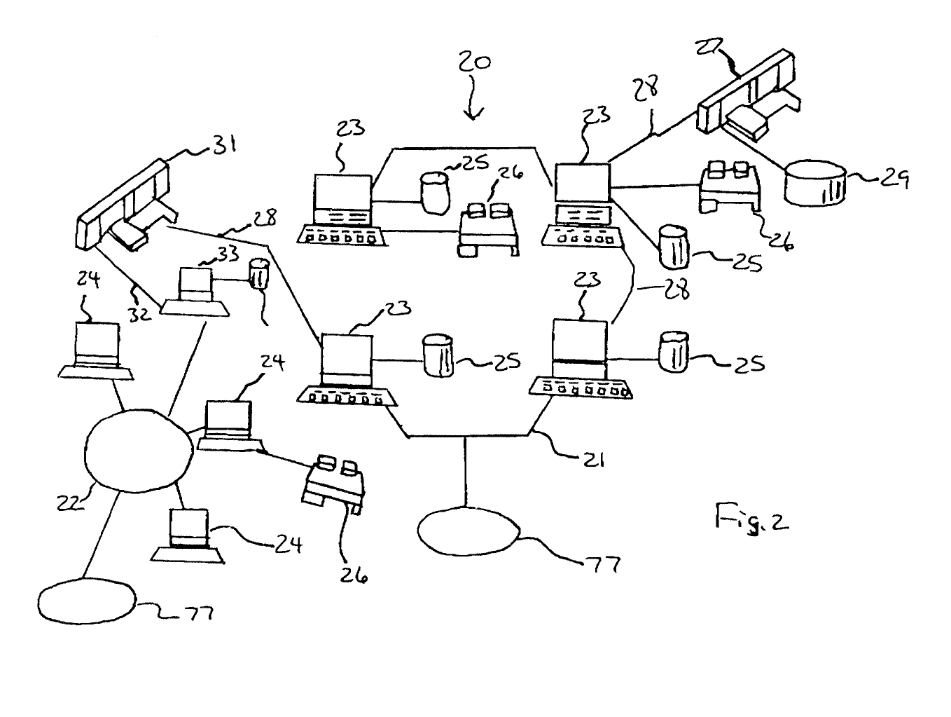

The method of the present invention may be implemented in a global computer network environment such as the Internet. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS) which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

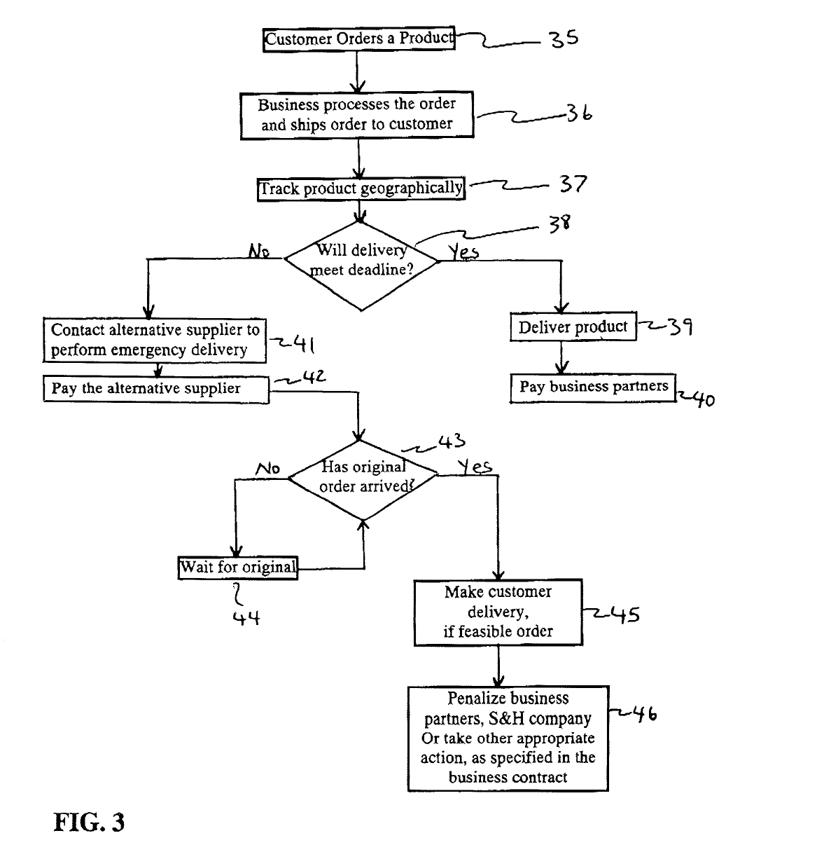

Referring to FIG. 3, there is a description of the overall method of this invention. As shown in step 35, a client places an order with a business for a product. The client will provide, as part of the order, the requirements for the purchase and delivery of the product. This information will include the identity of the product, the quantity of the product, the product delivery destination and the delivery time. The delivery time could be a specific time or a specified time period. The business receives and processes this information in step 36. This business entity can be an actual supplier of the ordered product or a business that coordinates the purchase and delivery of products. As part of the processing function, the business will locate a supplier of the ordered product, if that business does not have or supply the actual goods. The business schedules the order with the supplier. The business will also select the shipping and handling entity to deliver the product. Lastly, the business will calculate prices and fees and charge the client for the purchase and delivery of the product. Once this business entity has compiled the information concerning this transaction, the information is stored in a business database. As part of this transaction between the client and the business, there can be an agreement containing all of the terms and conditions of the transaction.

After processing the purchase order, the selected shipping and handling entity assembles and ships the order to the designated destination. The shipping and handling entity (S&H) will design a shipping route for the delivery. Once shipping has begun, the next step 37 is to track the progress of the shipment geographically along the shipping route. The shipping route can contain geographic checkpoints and a time schedule of the delivery. Each checkpoint will have a time associated with it.

The method uses these checkpoints, in step 38, to track the progress of the delivery and the make a determination whether the delivery is on schedule at the particular checkpoint. If the determination is that the delivery is on schedule, the product delivery proceeds as planned. If after all checkpoints, the product delivery is on schedule, the product is delivered 39 to the designated destination. At this point, the S&H entity receives compensation for the performed delivery services 40. If the determination in step 38 is that the delivery is behind schedule and that the delivery will not reach the designated destination within the required time period, then an alternate supplier of the shipped product is contacted to perform an emergency delivery 41. This alternate supplier should preferably be located in close proximity to the delivery destination. This supplier will receive the client requirements for purchase and delivery of the product received by the business in step 35. The supplier will assemble the product order and use an S&H entity to make the delivery for the client instead of the original order. This alternate delivery will ensure that the product arrives at the destination within the specified time period. The alternate supplier will receive compensation for cost of the order and delivery services 42. The alternate supplier will probably also receive a fee for agreeing to perform the delivery service as an alternate supplier.

At this point, the product order has been delivered to the designated destination in time. However, the original order is still in route to the delivery destination. This order is still tracked to determine when it will reach the delivery destination 43. This arrival determination step 43 is periodically repeated, in step 44, until the order arrives at the destination. When the order does arrive at the destination location, there is a determination on the final delivery of this original order 45. The can be at least four delivery alternatives for this order. The first alternative can be to deliver the product to the original destination as planned. This delivery would result in the client receiving two orders of the product. Depending on the circumstances, the client may accept both orders. The next alternative can be to deliver the order to the alternate supplier. The alternate supplier could use this order to replace the delivered product in its inventory. Inventory swapping between suppliers of the same product are not unusual in many industries. A third alternative is to send the product back to the original supplier. This alternative may be viable depending on the willingness of the supplier to accept the product. It will also depend on the terms of the purchase and the delivery. If the delivery delay was solely the responsibility of the S&H entity, there may some compensation due to the original supplier in order for the supplier to accept the original order. The fourth alternative would be to deliver the product to a second client in the proximity of the first delivery destination. For example, if second client made a request for a similar order to the alternate supplier shortly after the alternate supplier agreed to fill the order for the original customer, this first product order could fill the second product order for the alternate supplier. The final solution to this delivery and any penalties resulting from the failure to deliver the original order in a timely manner should be covered by terms in the original purchasing agreement 46.

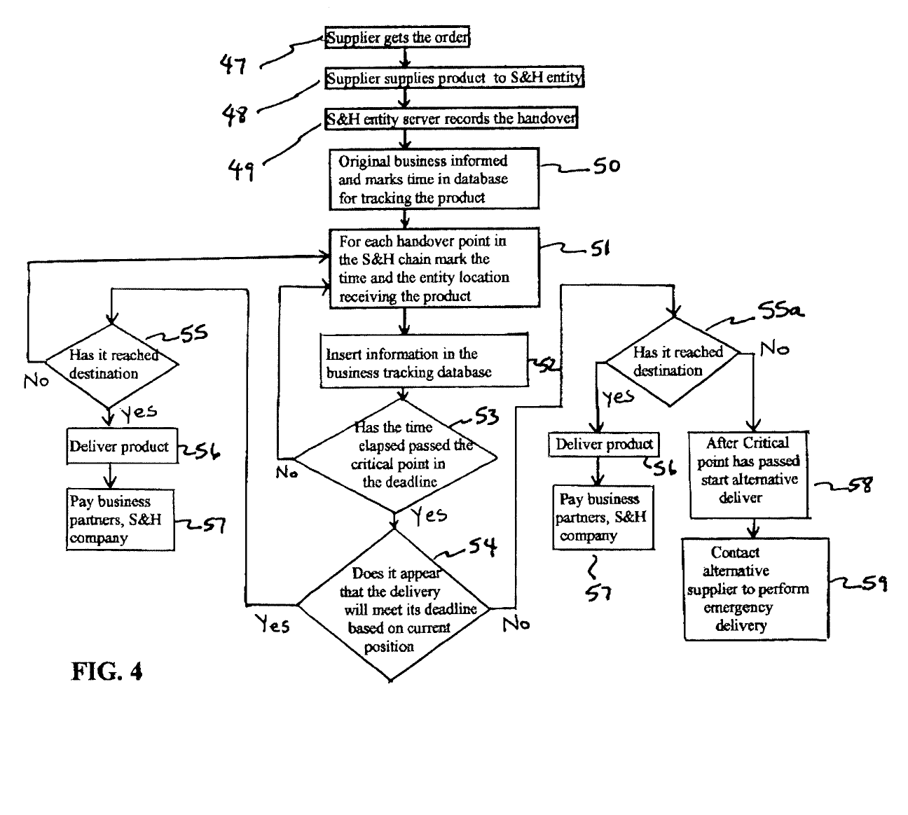

FIG. 4 gives a detailed illustration of the activities involved in the product delivery-tracking process in FIG. 3. As shown in step 47, the supplier receives the order from the customer. The supplier does the product processing, assembles the order and supplies the order to an S&H entity 48. The S&H entity records the exchange/handover of the order from the supplier in an S&H database 49. This database is generally located in a server at some computing network location or at the S&H entity facility. The original business, receiving the order from the client, is informed of the S&H transaction. The business stores that information in a business database and uses it for tracking the product during delivery 50. The delivery route is determined either jointly by the S&H, the supplier and the business taking into consideration the delivery requirements of the client or by any combination jointly or singularly by the three entities.

As previously mentioned, the shipping route can contain geographic checkpoints and a time schedule of the delivery. Each checkpoint will have a time associated with it. The shipping route will also contain information about the shipping means at each handover checkpoint. For example, this delivery route may have five checkpoints. This route will also have three shipment modes, railroad car, ship and truck. Checkpoints one and two may not involve a change in shipping mode. In this case, at some geographic point, only a time check will occur to determine whether the delivery is on schedule. Checkpoint three may be a transfer from the railcar to a ship. Checkpoint four will be the exchange from the ship to a truck. Checkpoint five would be only a geographic check to determine a status of the delivery. All of this delivery information will be stored in the business database and S&H database.

The delivery schedule will also contain a critical point at which the delivery must be on schedule or there will be decision to implement an alternate delivery plan. At each checkpoint, the time of the checkpoint/handover will be marked 51 and stored in the tracking database 52. During the periodic status checks, there will an examination of the time to determine if the time has passed this critical point 53. If the time has not passed the critical point, the delivery process returns to and repeats step 51. However, if the delivery time has passed the critical point, there is determination whether the delivery can meet the delivery requirement based on the current delivery circumstances 54. These circumstances include the current location of the order along the delivery route at the critical point. If the determination is that the delivery can reach the destination within the delivery requirements, there is determination whether the delivery has reached the destination 55. If the delivery has not reached the destination, the process returns to step 51. The continual evaluation of the delivery process is necessary until the order reaches the delivery destination. If the delivery has reached the final destination, the product is delivered to the client 56 and the parties to the delivery are compensated 57 in accordance with the terms of the purchase and shipping agreement.

Referring to step 54, if it does not appear that the delivery will be within the time requirements of the client, then an alternate delivery process is implemented 58 and the supplier of the shipped product is contacted to perform an emergency delivery 59 as is done in step 41 of FIG. 3. As shown, when step 54 determines that the deliver will not meet the deadline, the process moves step 55a where there is determination whether the delivery has reached the destination. At this point, this decision step primarily relates to the original shipment. Even though an alternate shipment has been ordered and shipped to the destination site, one alternative is to still deliver the original shipment to the destination. Step 55a will periodically repeat its inquiry until the original shipment arrives and is delivered in accordance with steps 56 and 57.

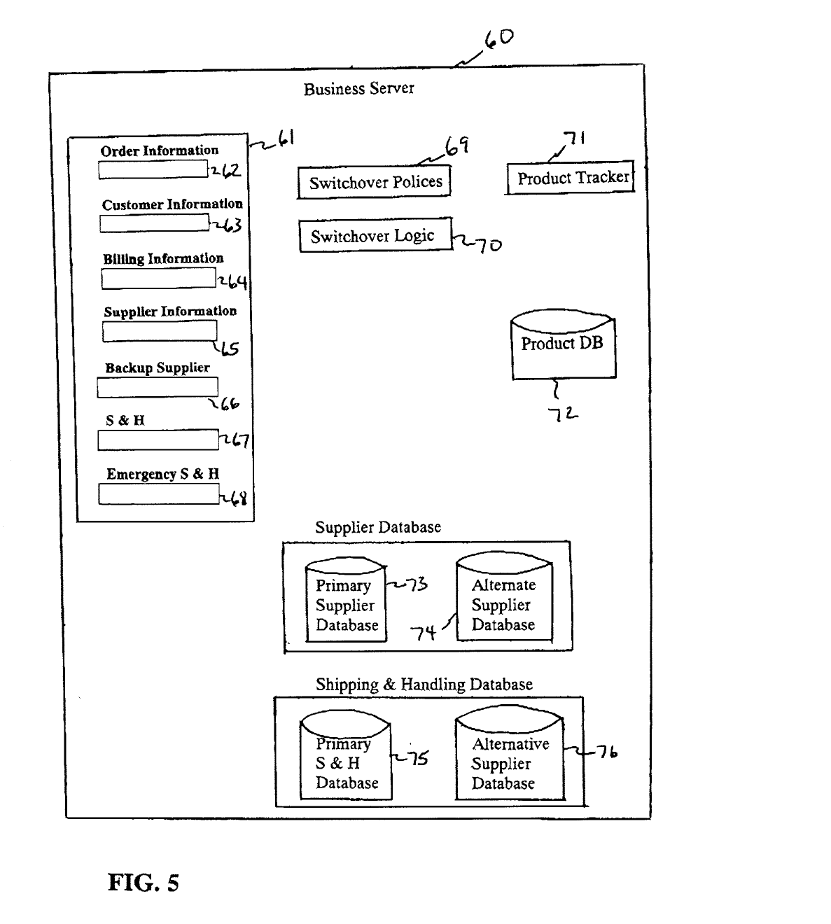

FIG. 5 shows a structural diagram of a business server 60. This server can contain all of the functional features of the present invention. As shown, the server has a section 61 that contains information for a specific order. This section contains client information 62 which can include general client identity information client such as name, address and telephone number. Box 63 contains information about the particular order. This information includes the previously discussed requirements for purchase and delivery of the product. Box 64 contains the billing information for the particular transaction. Boxes 65, 66, 67, and 68 respectively contain information about the specific product supplier, backup supplier, shipping and handling entity and the emergency S&H entity for a particular delivery.

The business server 60 also contains general information that is used in the implementation of the present invention during the delivery of a product. Box 69 contains the switchover policies that determine at what point to implement a delivery of the product from an alternate supplier. Box 70 describes the actual techniques that implement the product delivery switchover. As previously mentioned after shipment, each individual product order is tracked using techniques contained in box 71. The product database 72 can contain all of the product orders from the shipping business that are currently in route to a client destination. Also contained in the business server is supplier information in the form of a supplier database 73 of suppliers of a product and an alternate/emergency supplier database 74. The alternate supplier database contains information such as supplier names, areas covered by each supplier, the minimum time required to implement an emergency delivery switchover (alternate delivery) and the cost of such a delivery. The server also has databases for primary 75 and alternative 76 shipping and handling information. Similar to the supplier and alternate supplier databases, the primary S&H database contains information about shipping companies in close proximity to the client. The alternate database 76 contains information about shipping companies in other geographic locations where the client may do business. A specialized shipping and handling entity (probably more expensive) would handle an emergency switchover. Each shipping and handling entity could serve a specified area in case of the need for an emergency switchover.

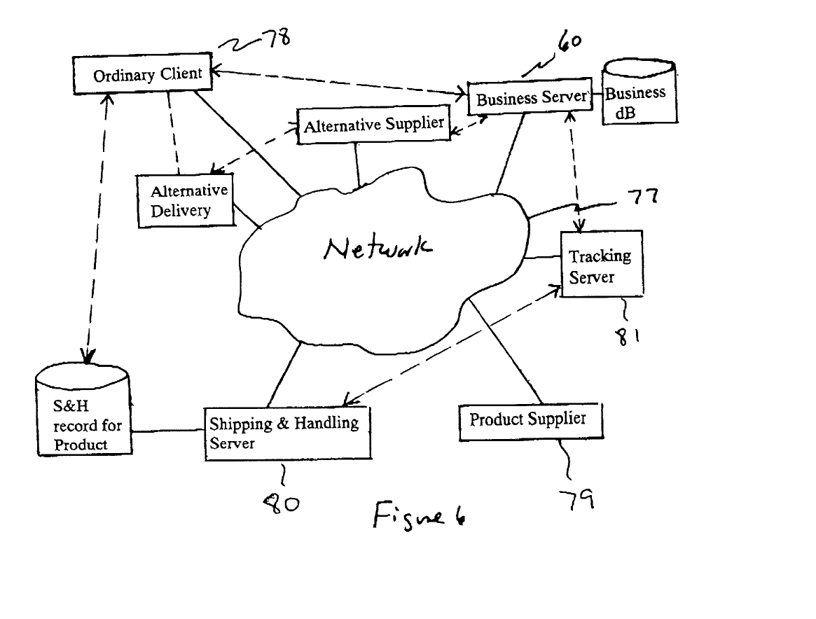

FIG. 6 shows an example of the different communication connections for the various entities in the system of the present invention. This illustration is for the case where the various components and functions of the invention are physically in different geographic locations. As shown many of the communications occur via a global communication network 77 such as the Internet. A client seeking to have a product shipped to a destination can communicate with various entities in order to achieve the desired objective. As shown, some of these communications can be directly with the particular entity or via the communication network. In the example in FIG. 6, a client in one location can order a product to be shipped from a second location to a destination location. The client 78 can contact a product supplier 79 via network 77 to order the shipment of a product to a desired destination. The supplier can contact a shipping and handling entity through the shipping and handling server 80. Tracking of the delivery can be as previously described using a tracking server 81. When needed alternative product suppliers and shipping and handling entities can be found through the databases and contacted via the communication network 77 for emergency delivery of a substitute product order.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claim as new and desire to secure by Letters Patent is set forth in the following claims.

We claim:

1. A method for ensuring a delivery of a product to a delivery destination within a predetermined delivery time period comprising the steps of:
receiving a delivery order from a customer, the delivery order containing product information, delivery location and delivery time information;
processing the received delivery order;
shipping the order to the designated delivery location;
tracking the shipped order along a delivery route to assess the progress of the shipment to the delivery destination; and
implementing an alternative delivery program, if said order tracking indicates that the shipped order will not reach the delivery destination within the predetermined delivery time as specified in the client delivery order.

2. The method as described in claim 1 wherein said delivery order processing step further comprises the steps of:
recording the information contained in the client delivery order in a product delivery database;
scheduling the received order with a product supplier; and
selecting a shipping and handling entity to ship the product.

3. The method as described in claim 1 wherein said shipping step further comprises determining a delivery route for the product, the delivery route containing check points for tracking the product during delivery.

4. The method as described in claim 3 wherein said check points can be geographic points along the physical delivery route or time check points at designated times during the delivery.

5. The method as described in claim 4 wherein said tracking step further comprises the steps of:
monitoring the checkpoints to determine the progress of the delivery;
calculating a revised delivery time based on the progress of the delivery; and
determining whether the predetermined product delivery time can be achieved based on the calculated and revised delivery time.

6. The method as described in claim 1 wherein said alternative delivery implementation step comprises:
contacting an alternative product supplier;
providing said alternative supplier with the client order containing product information, delivery location and delivery time information; and
shipping the product from the alternative supplier to the delivery destination.

7. The method as described in claim 6 further comprising the step of determining a delivery location for the initial product order to the customer.

8. The method as described in claim 7 wherein the initial product order is delivered to the initial delivery destination.

9. The method as described in claim 7 wherein initial product order is delivered to the location of the alternative product supplier.

10. The method as described in claim 1 wherein said alternative delivery implementation step comprises exchanging the product of an alternative product supplier located in close proximity to the delivery location with the shipped product, the shipped product becoming part of the alternative supplier's product inventory.

11. The method as described in claim 7 wherein the product of the original product order is returned to the initial product supplier.

12. A method for tracking the delivery of a product to a designated destination within a predetermined delivery time comprising the steps of:
receiving a delivery order from a customer, the delivery order containing information, which includes product information, product delivery location and product delivery time information;
supplying a product and product information to a shipping and handling entity;
determining a delivery route for the product, the delivery route containing product handover points along the route for the product;
recording the transfer of the product order from the product supplier to the shipping and handling entity;
tracking the shipped order along a delivery route based on elapsed time to assess the progress of the shipment to the delivery destination; and
implementing an alternative delivery program, if said order tracking indicates that the shipped order will not reach the delivery destination within the predetermined delivery time as specified in the client delivery order.

13. The method as described in claim 12 further comprising after said transfer recording step, the step of informing the client of the transfer of the order from the supplier to the shipping and handling entity.

14. The method as described in claim 12 wherein said recording step comprises entering the time of the transfer of the product from the supplier to the shipping and handling entity in a business tracking database.

15. The method as described in claim 12 wherein said tracking step comprises for each exchange of the product order from one shipping and handling to another shipping handling entity, recording the time of the exchange and the names of the shipping and handling entities involved in the exchange.

16. The method as described in claim 15 wherein said tracking step further comprises establishing a critical time during the delivery process and determining at each shipping and handling exchange whether the delivery process has passed the critical time.

17. The method as described in claim 16 further comprising at each shipping and handling exchange determining whether a delivery will reach the designated destination in the predetermined delivery time based on the location and time of a particular exchange.

18. The method as described in claim 17 further comprising when there is a determination that the product will reach the designated destination, the steps of:
determining whether product has reached the predetermined destination; and
delivering the product when product has reached the predetermined destination.

19. The method as described in claim 17 further comprising when there is a determination that the product will not reach the designated destination, the steps of:
contacting an alternative product supplier;
providing said alternative supplier with the client order containing product information, delivery location and delivery time information; and
shipping the product from the alternative supplier to the delivery destination.

20. The method as described in claim 19 wherein the initial product order is delivered to the initial delivery destination.

21. The method as described in claim 19 wherein initial product order is delivered to the location of the alternative product supplier.

22. The method as described in claim 12 wherein said alternative delivery implementation step comprises exchanging the product of an alternative product supplier located in close proximity to the delivery location with the shipped product, the shipped product becoming part of the alternative supplier's product inventory.

23. A computer program product in a computer readable medium for ensuring a delivery of a product to a delivery destination within a predetermined delivery time period comprising:
instructions for receiving a delivery order from a customer, the delivery order containing product information, delivery location and delivery time information;
instructions for processing the received delivery order;
instructions for shipping the order to the designated delivery location;
instructions for tracking the shipped order along a delivery route to assess the progress of the shipment to the delivery destination; and
instructions for implementing an alternative delivery program, if said order tracking indicates that the shipped order will not reach the delivery destination within the predetermined delivery time as specified in the client delivery order.

24. The computer program product as described in claim 23 wherein said delivery order processing instruction further comprises:
instructions for recording the information contained in the client delivery order in a product delivery database;
instructions for scheduling the received order with a product supplier; and
instructions for selecting a shipping and handling entity to ship the product.

25. The computer program product as described in claim 23 wherein said ship instruction farther comprises instructions for determining a delivery route for the product, the delivery route containing check points for the product.

26 The computer program product as described in claim 25 wherein said tracking instruction further comprises:
instructions for monitoring the checkpoints to determine the progress of the delivery;
instructions for calculating a revised delivery time based on the progress of the delivery; and
determining whether the predetermined product delivery time can be achieved based on the revised delivery time.

27. The computer program product as described in claim 23 wherein said alternative delivery implementation instruction comprises:
instructions for contacting an alternative product supplier;
instructions for providing said alternative supplier with the client order containing product information, delivery location and delivery time information; and
instructions for shipping the product from the alternative supplier to the delivery destination.

28. The computer program product as described in claim 27 further comprising instructions for determining a delivery location for the initial product order to the customer.

29. The computer program product as described in claim 28 further comprising instructions for delivering the initial product order to the initial delivery destination.

30. The computer program product as described in claim 28 further comprising instructions for delivering initial product order to the location of the alternative product supplier.

31. The computer program product as described in claim 28 further comprising instructions for returning the initial product order to the to the initial product supplier.

32. The computer program product as described in claim 23 wherein said alternative delivery implementation instruction comprises instructions for exchanging the product of an alternative product supplier located in close proximity to the delivery location with the shipped product, the shipped product becoming part of the alternative supplier's product inventory.

33. A system for ensuring a delivery of a product to a delivery destination within a predetermined delivery time period comprising:
a communication interface for establishing communication between a client desiring to ship a product and a business entity that can ship the client's product, said communication interface enabling the client to submit purchase and shipping information to the business entity;
a program that can process any information received by the business entity from the client related to the purchase and shipment of the product;
a program for tracking the shipped order along a delivery route to assess the progress of the shipment to the delivery destination;
a switchover entity capable of implementing an alternative delivery program, when said tracking program indicates that the shipped order will not reach the delivery destination within the predetermined delivery time as specified in the client delivery order; and
a database component to store all product information related to the purchase, shipment and delivery of a client order.

34. The system as described in claim 33 wherein said processing program, tracking program, switchover entity and database component are contained in a server at one location.

35. The system as described in claim 33 wherein the communication between the client and the business entity occurs via said communication interface over a communication network.

36. The system as described in claim 33 wherein said switchover entity comprises a decision making component that determines whether to implement the alternative delivery program based on information from the tracking program.

37. The system as described in claim 36 wherein said decision making entity comprises switchover policies with guidelines that cover the implementation of alternative delivery programs and switchover logic that performs the actual alternative deliver program implementation.

38. The system as described in claim 33 wherein said database component comprises supplier and shipping and handling databases.

39. The system as descried in claim 38 wherein said supplier and shipping and handling databases are in different physical locations.

40. The system as described in claim 33 further comprising multiple servers, each server being in communication with said other servers, said servers being in different locations and containing said processing program, tracking program, switchover entity and database component.
